(19) United States
(12) Patent Application Publication
(10) Pub. No.: US 2026/0017948 A1
(43) Pub. Date: Jan. 15, 2026

(54) METHOD AND APPARATUS FOR VIDEO INTERACTION BASED ON LARGE MODEL, AND PRODUCT

(71) Applicant: Beijing Baidu Netcom Science Technology Co., Ltd., Beijing (CN)

(72) Inventors: Kaihuan WEI, Beijing (CN); Xiaohua REN, Beijing (CN); Xiaolin HUANG, Beijing (CN); Huibin ZHAO, Beijing (CN); Tian WU, Beijing (CN)

(21) Appl. No.: 19/334,402

(22) Filed: Sep. 19, 2025

(30) Foreign Application Priority Data
Jul. 25, 2025 (CN) 202511038178.X

(51) Int. Cl. G06V 20/40; G06V 10/80; G06V 10/86; G06V 10/94; G06V 20/62; G06V 20/70; G06V 30/262

(52) U.S. Cl. CPC G06V 20/41; G06V 10/811; G06V 10/86; G06V 20/63; G06V 20/70; G06V 30/274; G06V 10/95

(57) ABSTRACT

A method for video interaction, an electronic device, and a storage medium are provided. The method may include: during a video interaction with a large model, determining a target object targeted by a spatially directional action associated with a video frame in an interaction process; determining a data processing instruction for the target object based on input information linked to the spatially directional action; and using the large model to perform data processing on the target object according to the data processing instruction, thereby obtaining a data processing result.

### CROSS-REFERENCE TO RELATED APPLICATIONS

This application claims the priority from Chinese Patent Application No. 202511038178.X, filed on Jul. 25, 2025, the entire disclosure of which is hereby incorporated by reference.

### TECHNICAL FIELD

This disclosure relates to the field of artificial intelligence technology, specifically to technical fields such as large models, natural language understanding, and video understanding. In particular, it relates to a method and an apparatus for video interaction based on a large model, an electronic device, a storage medium, and a computer program product, which may be applied to scenarios such as video calls and screen sharing.

### BACKGROUND

Existing AI (Artificial Intelligence) systems can achieve a certain level of human-computer interaction in scenarios such as video calls and screen sharing. However, these AI systems have limitations in understanding user intentions during the human-computer interaction process.

### SUMMARY

This disclosure provides a method and an apparatus for video interaction based on a large model, an electronic device, a storage medium, and a computer program product.

According to a first aspect, a method for video interaction based on a large model is provided, including: determining, during a video interaction process with the large model, a target object directed by a spatially directional action associated with a video frame in the video interaction process; determining a data processing instruction for the target object according to input information associated with the spatially directional action; and using the large model to perform data processing on the target object according to the data processing instruction, to obtain a data processing result.

According to a second aspect, an electronic device is provided, including: at least one processor; and a memory communicatively connected to the at least one processor; where the memory stores instructions executable by the at least one processor, and the instructions are executed by the at least one processor to enable the at least one processor to perform the method described in any embodiment of the first aspect.

According to a third aspect, a non-transitory computer-readable storage medium storing computer instructions is provided, where the computer instructions are used to cause a computer to execute the method described in any embodiment of the first aspect.

It should be understood that the content described in this section is not intended to identify key or important features of the embodiments of this disclosure, nor is it intended to limit the scope of this disclosure. Other features of this disclosure will become readily understood through the following description.

### BRIEF DESCRIPTION OF THE DRAWINGS

The drawings are for a better understanding of the present disclosure and do not constitute a limitation of the present disclosure. Here:

FIG. 1 is a diagram of an example system architecture to which an embodiment of the present disclosure may be applied;

FIG. 2 is a flowchart of a method for video interaction based on a large model according to an embodiment of the present disclosure;

FIG. 3 is a schematic diagram of an application scenario of the method for video interaction based on a large model according to an embodiment;

FIG. 4 is a schematic diagram of a text-image combined data processing instruction according to the present embodiment;

FIGS. 5A-5G are schematic diagrams of a data processing process based on multiple spatially directional actions according to the present embodiment;

FIG. 6 is a flowchart of the method for video interaction based on a large model according to another embodiment of the present disclosure;

FIG. 7 is a flowchart of the method for video interaction based on a large model according to another embodiment of the present disclosure;

FIG. 8 is a structural diagram of the apparatus for video interaction based on a large model according to an embodiment of the present disclosure;

FIG. 9 is a structural diagram of a computer system adapted for implementing the embodiments of the present disclosure.

### DETAILED DESCRIPTION OF EMBODIMENTS

The following description of exemplary embodiments of the present disclosure, taken in conjunction with the accompanying drawings, includes various details of embodiments of the present disclosure to facilitate understanding, and is to be considered as exemplary only. Accordingly, one of ordinary skill in the art will recognize that various changes and modifications may be made to the embodiments described herein without departing from the scope and spirit of the disclosure. Also, for clarity and conciseness, descriptions of well-known functions and structures are omitted from the following description.

In the technical solutions of the present disclosure, the collection, storage, use, processing, transmission, provision, disclosure, and other handling of user personal information all comply with relevant laws and regulations and do not violate public order and good customs.

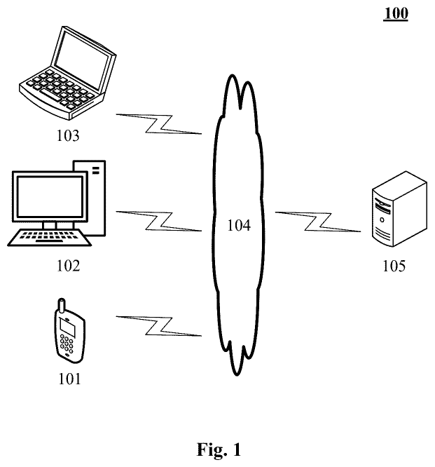

FIG. 1 shows an example architecture 100 to which a method and an apparatus for video interaction based on a large model according to the present disclosure may be applied.

As shown in FIG. 1, the system architecture 100 may include terminal devices 101, 102, 103, a network 104, and a server 105. The terminal devices 101, 102, 103 are communicatively connected to form a topological network. The network 104 serves as a medium for providing communication links between the terminal devices 101, 102, 103 and the server 105. The network 104 may include various types of connections, such as wired communication links, wireless communication links, or optical fiber cables.

The terminal devices 101, 102, 103 may be hardware devices or software that support network connections for data interaction and data processing. When the terminal devices 101, 102, 103 are hardware, they may be various electronic devices that support network connections and functions such as information acquisition, interaction, display, and processing, including but not limited to smartphones, tablets, e-book readers, laptop computers, and desktop computers. When the terminal devices 101, 102, 103 are software, they may be installed in the above-listed electronic devices. They may be implemented as multiple software programs or software modules (e.g., for providing distributed services) or as a single software program or software module, without specific limitations herein.

The server 105 may be a server that provides various services, such as a backend processing server that acquires multi-modal data (e.g., video frames displayed by the terminal devices 101, 102, 103, user input information for the video frames, and spatially directional actions) and performs human-computer interaction based on the multi-modal data. As an example, the server 105 may be a cloud server.

It should be noted that the server may be hardware or software. When the server is hardware, it may be implemented as a distributed server cluster consisting of multiple servers or as a single server. When the server is software, it may be implemented as multiple software programs or software modules (e.g., software or software modules for providing distributed services) or as a single software program or software module, without specific limitations herein.

It should also be noted that the method for video interaction based on a large model provided by the embodiments of the present disclosure is generally executed by the server, but it does not exclude the possibility of execution by the terminal device or collaborative execution by the server and the terminal device. Correspondingly, all components (e.g., units) of the apparatus for video interaction based on a large model may be disposed in the server, all in the terminal device, or separately in the server and the terminal device.

It should be understood that the numbers of terminal devices, networks, and servers in FIG. 1 are merely illustrative. Any number of terminal devices, networks, and servers may be used according to implementation requirements. When the electronic device on which the method for video interaction based on a large model runs does not need to transmit data with other electronic devices, the system architecture may only include the electronic device (e.g., a terminal device or a server) on which the method for video interaction based on a large model runs.

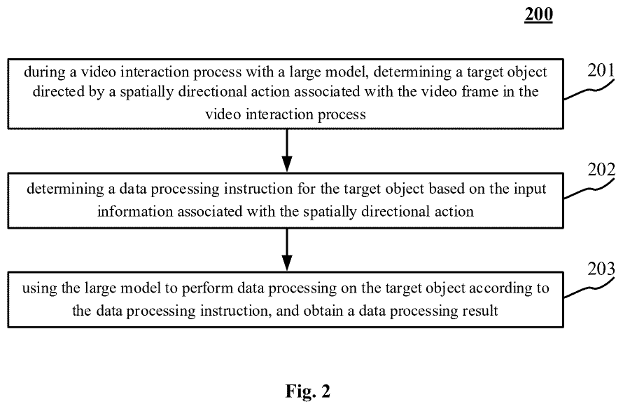

Please refer to FIG. 2, which is a flowchart of a method for video interaction based on a large model provided by an embodiment of the present disclosure. The process 200 includes the following steps.

Step 201: during a video interaction process with a large model, determining a target object directed by a spatially directional action associated with the video frame in the video interaction process.

In this embodiment, the execution subject of the method for video interaction based on a large model (e.g., the server in FIG. 1) may acquire, from the user terminal device via a wired or wireless network connection, the video frame in the video interaction process between the user and the large model, and the spatially directional action associated with the video frame; and determines the target object directed by the spatially directional action associated with the video frame.

The video frame is a real-time video frame displayed by the user terminal device, which may be a video frame in a video call or a video frame in a screen sharing session. The video frame may be acquired in real time through screen recording, direct video stream acquisition via a camera or player, etc. It should be noted that any acquisition method requires obtaining the user authorization before performing real-time acquisition of the video frame.

The spatially directional action associated with the video frame may be an action performed by the user on the display screen of the video frame—for example, spatially directional actions such as clicking, touching, circling, drawing, or dragging on the target object in the display screen via a mouse pointer or touch screen; or eye movements representing the user gaze point or gaze trajectory in the video frame (in this case, eye tracking technology, such as an eye tracker, is required to acquire the spatially directional action). Alternatively, the spatially directional action may be a spatially directional action expressed by the user through gestures or other body movements in the video frame—for example, the user points to, circles, or grabs a target object in the real environment with a finger, and the real environment including the physical gesture is captured by a camera to acquire the video frame in real time.

The target object may be any object in the video frame, which may be a real physical object (e.g., a flower or a utensil), a non-physical object presented in the form of text, graphics, symbols, etc., or a virtual object generated by a computer with the development of technologies such as virtual reality (VR) and augmented reality (AR).

The user may conduct video interactions (e.g., video calls or screen sharing) with the large model. A large model (artificial intelligence large model) refers to a type of artificial intelligence model with a large number of parameters constructed using artificial neural networks, such as large language models, large vision models, multi-modal large models, and basic science large models. Taking a large language model as an example, the large model is a large-scale language model built based on deep learning technology, mainly used for natural language processing tasks. Through training on large-scale data, the large model learns language patterns and structures and can generate natural language text or understand natural language input. This embodiment may specifically adopt a multi-modal large language model, which typically includes the following modules.

An input module is configured to receive multi-modal data input by the user, such as text, images, videos, and input information, including text generation requests such as questions, instructions, or dialogue content;

A preprocessing module is configured to preprocess the input multi-modal data, for example, preprocessing of text data including operations such as word segmentation, stop-word removal, and text cleaning to convert the text into a format processable by the model; and

An encoding module is configured to encode the preprocessed multi-modal data into a vector format to enable the model to understand and process the data. Common encoding methods include word embedding and encoders in the Transformer architecture. Word embedding includes, for example, Word2Vec (Words to Vector) and GloVe (Global Vectors for Word Representation).

A model module, the core part, is generally configured to, based on a deep learning architecture (e.g., Transformer), to process the encoded data vectors and performs language understanding and generation. Through a multi-layer neural network structure, the model learns complex language patterns and semantic relationships.

A decoding module is configured to decode the output vectors of the model into natural language text, images, videos, or input information, and generate responses or processing results for the user input. Decoding methods may include greedy decoding, beam search, etc.

An output module is configured to output the decoded text in a user-readable form, such as text, images, videos, or input information displayed on a screen.

As an example, first, the target object directed by the spatially directional action is determined based on the type of the spatially directional action. For example, in response to determining that the spatially directional action is an action performed by the user on the display screen of the video frame, the position directed by the spatially directional action is determined based on the display screen; and in response to determining that the spatially directional action is a spatially directional action expressed by the user through gestures or other body movements in the video frame, the target object directed by the spatially directional action is determined by recognizing the spatially directional action in the video frame.

As another example, the implementation type of the spatially directional action and the video frame are input into a pre-trained target object recognition model, which outputs the target object directed by the spatially directional action. The target object recognition model is used to represent the relationship between the implementation type of the spatially directional action, the video frame, and the target object directed by the spatially directional action. The target object recognition model may be obtained by training a neural network (e.g., a recurrent neural network or a convolutional neural network) using machine learning algorithms such as supervised learning. The target object recognition model may be implemented by a large model.

During the recognition of the target object, data processing may be performed using, but not limited to, at least one of the following methods:

Object recognition: A pre-trained vision model is used to recognize the visual object covered or adjacent to the mouse pointer or touch point, such as user interface elements (buttons, text boxes, scroll bars), specific text content (titles, paragraphs, keywords), specific regions in images, or specific objects/people in videos.

Semantic segmentation or instance segmentation: Based on the context of the user dialogue, fine-grained semantic segmentation or instance segmentation is performed on the video frame to determine the semantic category (e.g., “chart area”, “text area”) or specific instance object (e.g., “the Q3 bar chart in the sales trend chart”) of the area where the mouse pointer or touch point is located.

Context understanding: The target object directed by the spatially directional action is determined by combining the surrounding visual elements of the spatially directional action and the overall layout of the frame. For example, if the spatially directional action points to an interactive button, the recognized target is “button”; if the spatially directional action points to a specific text paragraph, the recognized target object is “text paragraph”; if the spatially directional action points to a person face, the recognized target is “human face”.

Step 202: determining a data processing instruction for the target object based on the input information associated with the spatially directional action.

In this embodiment, the execution subject may determine a data processing instruction for the target object based on the input information associated with the spatially directional action.

The input information associated with the spatially directional action refers to the input information provided by the user when performing the spatially directional action. The input information may be represented in at least one form such as text, voice, or image. Taking text as an example, when performing the spatially directional action, the user may input text data to the execution subject. For instance, in response to detecting the user spatially directional action, the execution subject displays a text input box on the terminal screen, and the text information input by the user through the text input box is the input information associated with the spatially directional action. Taking voice as an example, the user may speak while performing the spatially directional action. In this case, the user can intuitively express their intention by combining “pointing” (manifested as a spatially directional action) and “speaking” (manifested as voice). For example, the user points to a “flower” in the video frame and says, “What kind of flower is this?” Taking an image as an example, the user may input image data to the execution subject while performing the spatially directional action. For instance, in response to detecting the user spatially directional action, the execution subject displays an image upload box on the terminal screen, and the image data uploaded by the user through the image upload box is the input information associated with the spatially directional action.

Taking input information represented by voice and images as an example, the user says “Process this into the style shown in the uploaded image” while performing the spatially directional action, and uploads image data to the execution subject through the image upload box.

As an example, the semantics represented by the input information may be recognized—for example, voice-to-text technology is used to obtain the recognized text of the voice, and the recognized text is directly used as the data processing instruction for the target object.

As another example, in-depth understanding of the recognized text may be performed based on the video frame and the spatially directional action to determine the user true operation intention for the target object; then, a data processing instruction for the target object is generated based on the true operation intention. For instance, the video frame, the spatially directional action, and the recognized text are input into a large model, which determines the user true operation intention for the target object and generates the data processing instruction.

The data processing instruction may be various data processing instructions in scenarios such as office work, learning, and entertainment, including but not limited to:

Data processing instructions for obtaining static attributes of the target object at the geometric, physical, and semantic levels. Static attributes include but are not limited to size, material, color, texture, quality, transparency, reflectivity, and category.

Data processing instructions for retrieving prior knowledge or external knowledge base information related to the target object, including historical background, cultural connotations, functional uses, structural principles, ecological significance, related events, and multilingual interpretations.

Data processing instructions for real-time modification of the spatial pose, appearance features, and dynamic behavior of the target object in the frame. Modifications include, for example, displacement, rotation, scaling, deformation, color mapping, transparency adjustment, lighting condition changes, texture replacement, and redefinition of interactive relationships (e.g., collision, occlusion, adsorption, and linkage) with other objects.

Step 203: using the large model to perform data processing on the target object according to the data processing instruction, and obtain a data processing result.

In this embodiment, the execution subject may use the large model to perform data processing on the target object according to the data processing instruction, and obtain a data processing result.

In this embodiment, the data processing instruction is input into the large model. Based on its powerful natural language understanding and logical analysis capabilities, the large model deeply understands the data processing instruction, performs data processing on the target object based on the understanding result, and obtains and displays the data processing result through the user terminal device. The data processing result may be represented in data forms such as text, input information, images, or videos, or in a combination of multiple data forms.

Continuing with the above example of the data processing instruction for analyzing the health status of a leaf, the large model extracts features from the image of the target object (leaf), determines the health status of the target object based on the feature extraction result, and provides targeted suggestions according to the health status.

As another example, if the data processing instruction is “Change the yellow leaves of this plant to green”, the large model extracts features from the target object (plant), identifies the yellow leaves based on the feature extraction result, and adjusts the yellow leaves of the plant in the video frame to green.

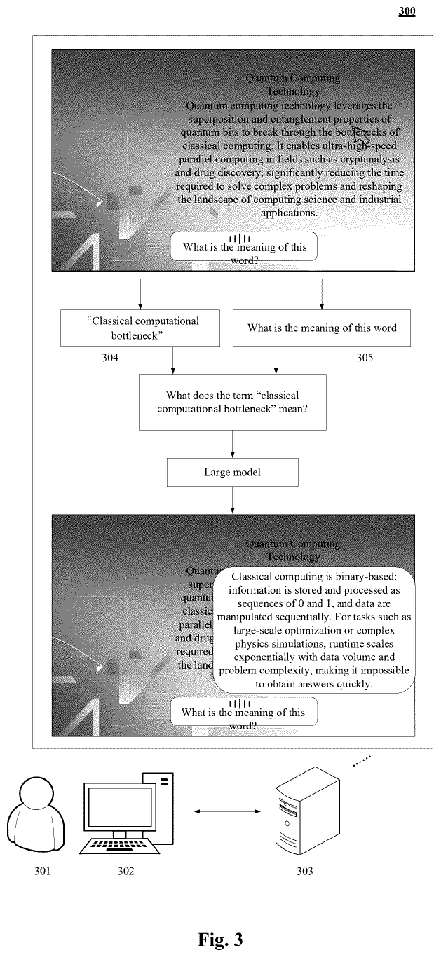

Continuing to refer to FIG. 3, which is a schematic diagram of an application scenario of the method for video interaction based on a large model according to the present embodiment. A user 301 is processing a presentation via a terminal device 302 and hopes to receive assistance from an AI system set in a server 303 during the presentation processing by sharing the screen. During the processing, the user encounters a technical term “classical computing bottleneck” in the presentation that they do not understand. They point to the technical term 304 in the current video frame displayed on the terminal device using a mouse pointer and ask, “What is the meaning of this term?” (voice 305). The AI system acquires the video frame, determines the technical term (target object) directed by the spatially directional action associated with the video frame, determines the data processing instruction “What is the meaning of the term ‘classical computing bottleneck’?” based on the query voice associated with the spatially directional action, uses the large model to perform data processing on the target object according to the data processing instruction, and obtains and displays the specific meaning of the technical term (data processing result) through the terminal device.

In this embodiment, a method for video interaction based on a large model is provided. During the video interaction process with the large model, the target object directed by the spatially directional action associated with the video frame is determined; a data processing instruction for the target object is determined based on the input information associated with the spatially directional action; and the large model is used to perform data processing on the target object according to the data processing instruction to obtain a data processing result. Thus, a human-computer interaction mode combining multi-modal data (spatially directional actions, video frames, and input information) is provided, allowing users to express intentions in an intuitive manner by combining spatially directional actions and information input (e.g., “pointing” and “speaking”). This reduces communication costs in the human-computer interaction process and improves the efficiency of understanding user intentions and the accuracy of processing during human-computer interaction.

In some optional implementations of this embodiment, the execution subject may perform Step 202 in the following manner:

First step: In response to the description part of the target object in the recognized text of the input information being an implicit reference description, generate a semantic description text of the target object.

First, the semantics of the input information are recognized to obtain the recognized text. For example, voice-to-text technology is used to obtain the recognized text of the voice, and the recognized text retains the timestamp of the input information; based on the timestamp of the recognized text and the timestamp of the spatially directional action, the description part of the target object in the recognized text is determined—for example, the part of the recognized text with the same timestamp as the spatially directional action is taken as the description part of the target object. To improve the accuracy of determining the description part of the target object in the recognized text, the description part may also be determined by combining semantic understanding of the recognized text and the timestamp.

Then, based on semantic understanding of the description part of the target object, it is determined whether the description part is an implicit reference description. An implicit reference description refers to a language expression that does not directly mention a specific person, event, or object (target object), but indirectly implies the referenced object through contextual information, mutually known information between the two parties, or other associated data. Examples include “this” and “which”.

Finally, in response to the description part of the target object in the recognized text being an implicit reference description, a semantic description text capable of representing the target object is generated. For example, the semantic description text indicates what kind of object the target object is (e.g., the category or name of the target object).

Second step: Determine the data processing instruction by combining the semantic description text and the recognized text.

In this implementation, the description part of the target object in the recognized text is replaced with the semantic description text to obtain a fused text in which the implicit reference description is converted into an explicit reference description, and the fused text is used as the data processing instruction. For example, if the recognized text is “What kind of species is this?” (where the implicit reference description of the target object is “this”) and the semantic description text of the target object is “a potted flower”, the fused text is “What kind of species is this potted flower?”.

In some implementations, to improve the semantic integrity and accuracy of the data processing instruction, a more informative semantic description text may be generated. The semantic description text may include basic attribute information (e.g., morphological features and appearance attributes), spatial positional relationship information (e.g., position and interaction relationship with other objects), state and action description information, function and attribute association information (for targets with specific functions, function descriptions may be included, such as “This device is a portable charger used to power electronic devices”; attribute associations with other objects may also be included, such as “This key matches the door lock on the right side of the frame”), and scenario and context information (e.g., “The book in the frame is placed on a library shelf, surrounded by books of the same category”).

In this implementation, the large model may be used to deeply understand the recognized text, determine the target information required to perform the data processing task represented by the recognized text based on the deep understanding result, further perform video understanding or image understanding on the target object to determine the target information of the target object, and generate the semantic description text accordingly.

In this implementation, when the description part of the target object in the recognized text is an implicit reference description, the data processing instruction is determined by combining the semantic description text of the target object and the recognized text, which improves the accuracy and integrity of the data processing instruction.

In some optional implementations of this embodiment, the execution subject may perform the second step in the following manner: first, determine the fused text by combining the semantic description text and the recognized text; then, combine the visual data of the target object with the description part of the target object in the fused text to determine the data processing instruction.

The visual data may be image data or video data of the target object. Taking image data as an example, the part of the video frame corresponding to the target object may be cropped to obtain visual data of the target object in image form. Taking video data as an example, the target video frames (including the target object) may be filtered from the multiple video frames displayed on the terminal device screen to obtain visual data of the target object in video form. To further improve the relevance of the visual data of the target object in video form, each target video frame including the target object may be cropped to a fixed size to obtain cropped frames, and the multiple cropped frames may be combined according to the temporal sequence of the target video frames to obtain visual data of the target object in video form (containing only the target object).

For example, image-form visual data may be used for static target objects, and video-form visual data may be used for dynamic target objects.

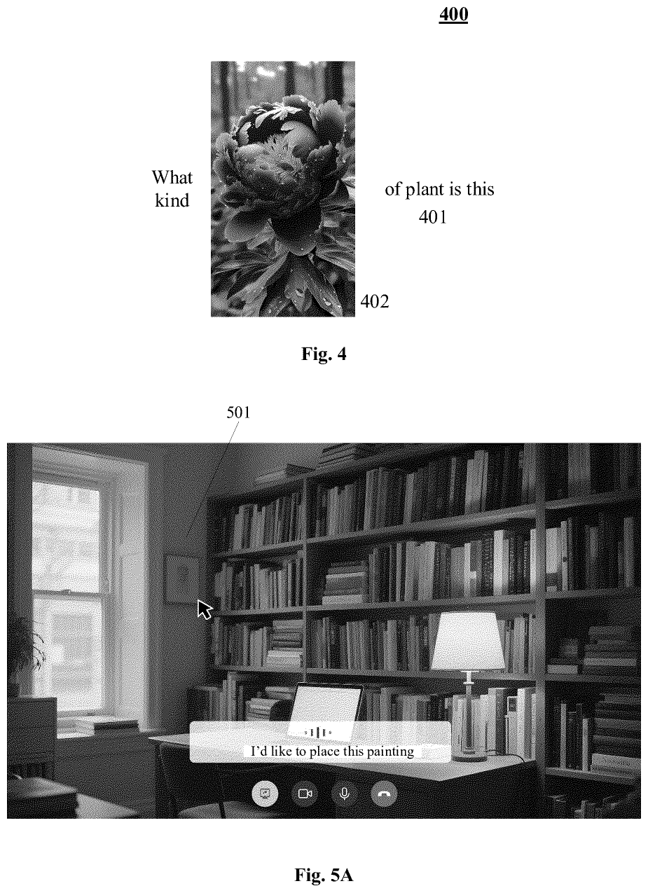

In this implementation, first, the description part of the target object in the recognized text is replaced with the semantic description text to obtain a fused text in which the implicit reference description is converted into an explicit reference description; then, the visual data of the target object is added after the description part of the target object in the fused text to generate a data processing instruction combining text and image or text and video. Continuing to refer to FIG. 4, a schematic diagram of a text-image combined data processing instruction is shown. The data processing instruction 400 includes an image part 401 (a potted peony flower) and a text part 402 (“What kind of species is this potted flower?”).

In this implementation, after clarifying the implicit reference description in the recognized text, the visual data of the target object is further combined to obtain a data processing instruction combining text and image or text and video. This further improves the data richness and semantic expressiveness of the data processing instruction, which helps to further improve the accuracy of the large model in understanding the intention based on the data processing instruction and the efficiency of data processing.

In some optional implementations of this embodiment, the execution subject may perform Step 202 in the following manner: in response to the description part of the target object in the recognized text of the input information being an explicit reference description, combine the visual data of the target object with the description part of the target object in the recognized text to determine the data processing instruction.

An explicit reference description refers to a language expression that directly and clearly refers to a specific object through explicit words or phrases, allowing the identity, scope, or features of the referenced object to be directly recognized and understood. For example, for a target object that is a peony flower, the description part may be “this potted peony flower”.

In this implementation, the visual data of the target object is added after the description part of the target object in the fused text to generate a data processing instruction combining text and image or text and video.

In this implementation, after determining that the description part of the target object in the recognized text is an explicit reference description, the visual data of the target object is further combined to obtain a data processing instruction combining text and image or text and video. This further improves the data richness and semantic expressiveness of the data processing instruction, which helps to further improve the accuracy of the large model in understanding the intention based on the data processing instruction and the efficiency of data processing.

In some optional implementations of this embodiment, one piece of input information may be associated with multiple spatially directional actions. For example, the user may perform multiple spatially directional actions while speaking. In terms of action type, the multiple spatially directional actions may be of the same type (e.g., two spatially directional actions both involve the user clicking on a target object in the video frame via a mouse pointer) or different types (e.g., one spatially directional action involves the user clicking on a target object in the video frame via a mouse pointer, and another involves the user selecting a target object in the video frame via eye movements). Generally, the multiple spatially directional actions aim at different target objects, but it does not exclude the possibility that they aim at the same target object.

In terms of temporal relationship, the multiple spatially directional actions may be performed by the user simultaneously (e.g., touching two target objects on the video frame with two fingers at the same time) or at different times (e.g., the first spatially directional action involves the user touching a first target object in the video frame with a finger, and the second involves touching a second target object in the video frame with a finger).

In terms of association relationship, the multiple spatially directional actions may be associated (e.g., swapping the positions of the target objects directed by the two spatially directional actions) or unassociated (e.g., the two spatially directional actions only point to two independent target objects with no connection, and the subsequent data processing processes for the two target objects are unrelated).

In this implementation, the execution subject may perform Step 202 in the following manner:

First step: For the multiple spatially directional actions, in response to the description part of the target object directed by each spatially directional action in the recognized text of the input information being an implicit reference description, generate a semantic description text of the target object.

First, the semantics of the input information are recognized to obtain the recognized text. For example, voice-to-text technology is used to obtain the recognized text of the voice, and the recognized text retains the timestamp of the input information; then, for each spatially directional action among the multiple spatially directional actions, the description part of the target object directed by the spatially directional action in the recognized text is determined based on the timestamp of the recognized text and the timestamp of the spatially directional action—for example, the part of the recognized text with the same timestamp as the spatially directional action is taken as the description part of the target object. To improve the accuracy of determining the description part of the target object in the recognized text, the description part may also be determined by combining semantic understanding of the recognized text and the timestamp. Based on semantic understanding of the description part of the target object directed by the spatially directional action, it is determined whether the description part is an implicit reference description. In response to the description part of the target object in the recognized text being an implicit reference description, a semantic description text capable of representing the target object is generated.

Second step: Perform temporal alignment between the recognized text of the input information and the multiple spatially directional actions, and determine the temporal relationship between the multiple spatially directional actions and the recognized text.

Based on the timestamp of the recognized text and the respective timestamps of the multiple spatially directional actions, temporal alignment is performed between the recognized text of the input information and the multiple spatially directional actions. The description parts of the recognized text with the same timestamps as the multiple spatially directional actions are determined, and the temporal relationship between the multiple spatially directional actions and the recognized text is obtained.

As an example, the recognized text is “Swap this object and this object”. The first “this object” matches the timestamp of the first spatially directional action (pointing to a peony flower), and the second “this object” matches the timestamp of the second spatially directional action (pointing to a Chinese rose). It can be understood that the description part with a temporal relationship to a spatially directional action is the description part of the target object directed by the spatially directional action.

Third step: Determine the data processing instruction by combining the semantic description text and the recognized text according to the temporal relationship.

As an example, for each spatially directional action whose description part of the target object is an implicit reference description, the input information description text of the target object directed by the spatially directional action is used to replace the description part of the recognized text with a temporal relationship to the spatially directional action, and the data processing instruction is obtained. That is, for each implicit reference description among the at least one implicit reference description associated with the input information, the semantic description text of the target object corresponding to the implicit reference description is used to replace the implicit reference description in the recognized text.

This implementation provides a method for generating a data processing instruction in the case of multiple spatially directional actions. By supporting multiple spatially directional actions, the flexibility and convenience of the user intention expression method (combining spatially directional actions and information input, such as “pointing” and “speaking”) are further improved, and the data processing methods for the target object are enriched.

In some optional implementations of this embodiment, the execution subject may perform the third step in the following manner: first, determine the fused text by combining the semantic description text and the recognized text according to the temporal relationship; then, for the multiple spatially directional actions, combine the visual data of the target object directed by each spatially directional action with the description part of the target object in the fused text to obtain the data processing instruction.

In this implementation, first, for each spatially directional action whose description part of the target object is an implicit reference description, the semantic description text of the target object directed by the spatially directional action is used to replace the description part of the recognized text with a temporal relationship to the spatially directional action, and a fused text in which the implicit reference description is converted into an explicit reference description is obtained; then, for each target object, the visual data of the target object is added after the description part of the target object in the fused text to generate a data processing instruction combining text and image, text and video, or text, image, and video. In the same data processing instruction, the visual data of the target objects directed by the multiple spatially directional actions may be in the same data form (e.g., image) or different data forms (e.g., the visual data of some target objects is in image form, and that of others is in video form).

In this implementation, after clarifying the implicit reference description in the recognized text, the visual data of the target objects directed by the multiple spatially directional actions is further combined to obtain the data processing instruction. This improves the data richness of the data processing instruction and enriches the data processing methods for the target object.

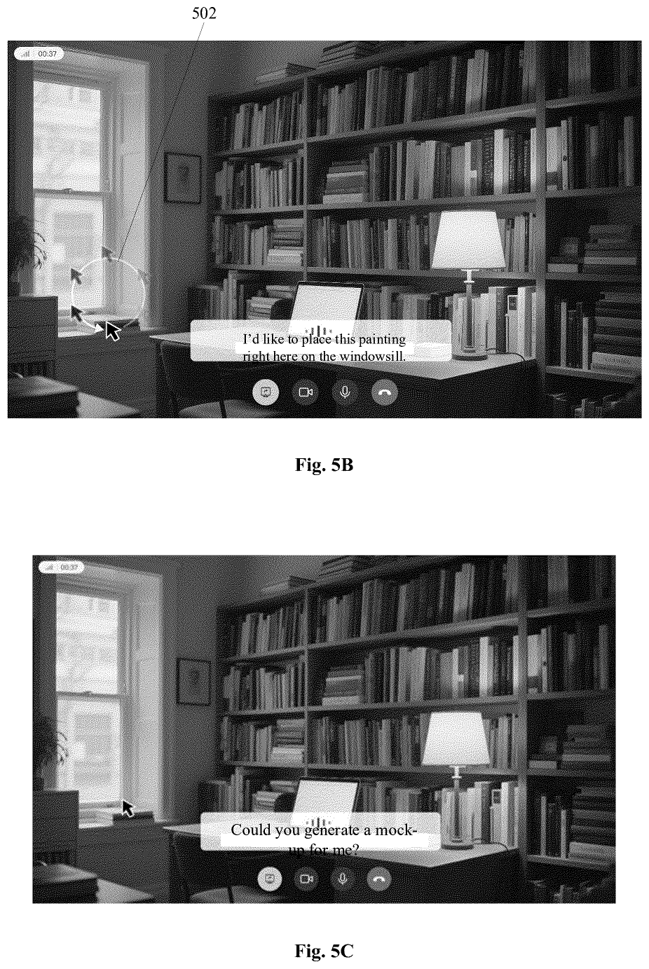

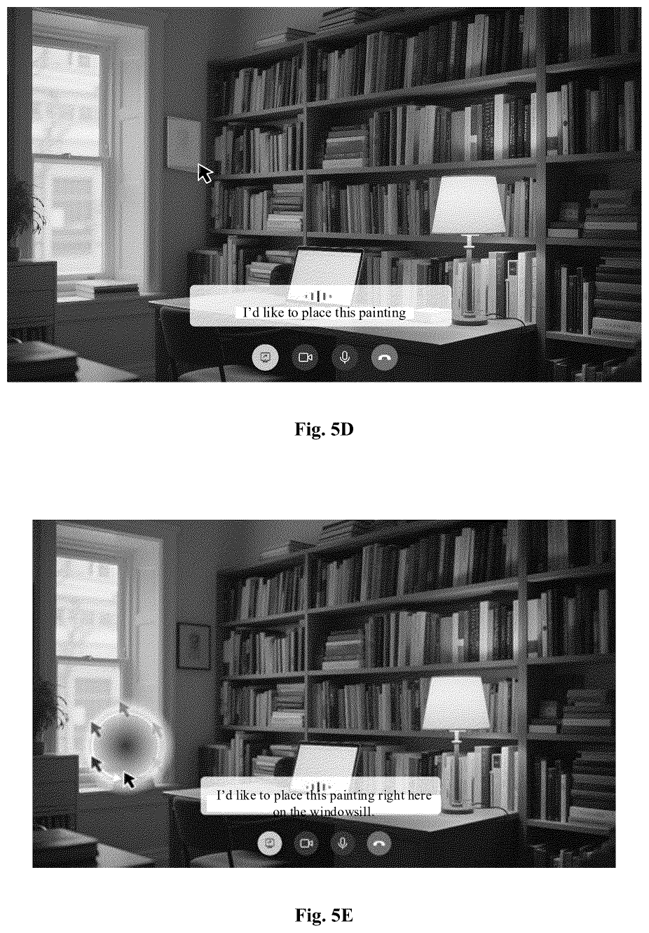

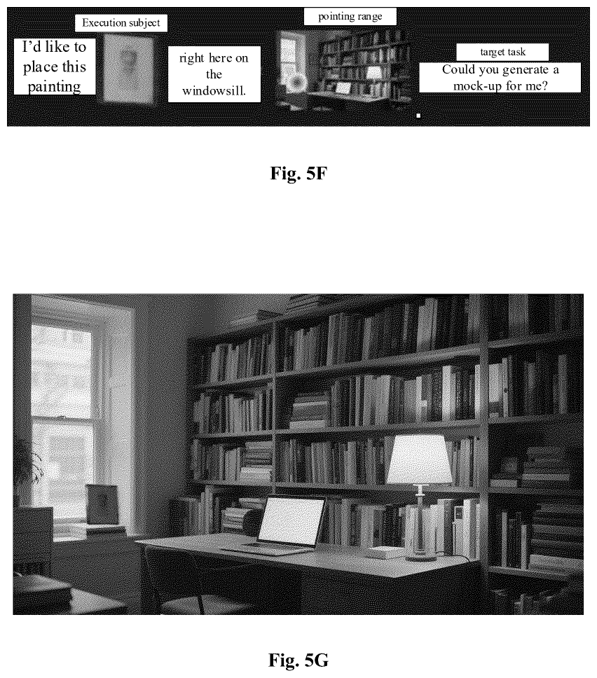

Continuing to refer to FIGS. 5A-5G, schematic diagrams of a data processing process based on multiple spatially directional actions are shown.

The user voice is “I want to place this painting in this position on the windowsill. Can you generate a render for me to see?”. Corresponding to the video frame shown in FIG. 5A, the user first spatially directional action involves clicking on the position corresponding to the “painting” 501 via a mouse pointer; corresponding to the video frame shown in FIG. 5B, the user second spatially directional action involves circling the target position range 502 on the “windowsill” via a mouse pointer; and the mouse pointer finally stops at the position shown in FIG. 5C.

For the first spatially directional action, the execution subject recognizes the target object directed by the action by combining the position pointed to by the first spatially directional action and the part of the voice recognition text corresponding to the first spatially directional action (“this painting”). The recognition result is shown in FIG. 5D.

For the second spatially directional action, the execution subject recognizes the target position range by combining the action trajectory of the second spatially directional action and the part of the voice recognition text corresponding to the second spatially directional action (“this position on the windowsill”). The recognition result is shown in FIG. 5E.

For each target object, the visual data of the target object is added after the description part of the target object in the fused text to generate a text-image combined data processing instruction, as shown in FIG. 5F.

The large model performs data processing on the target object based on the data processing instruction and obtains a data processing result, as shown in FIG. 5G.

In some optional implementations of this embodiment, the execution subject may perform Step 203 in the following manner: Use the large model to perform data processing on the target object according to the data processing instruction, the context of the input information, and the video frame, and obtain a data processing result.

As an example, the execution subject may use a multi-modal large model to deeply analyze the data processing instruction (combining the visual information and text information of the target object) and understand the complex intention contained therein. The large model can accurately distinguish the type of instruction (e.g., question, request for a specific operation, request for explanation, or emotional interaction). Further, the execution subject may input the data processing instruction, the context of the input information, and the video frame into the large model. The large model performs in-depth reasoning by combining the context of the historical dialogue, the overall semantics of the current video frame, and the precise target object pointed to by the user, and performs data processing on the target object based on the deep understanding result.

In this implementation, the large model performs data processing on the target object by combining the data processing instruction, the context of the input information, and the video frame, which further improves the accuracy of the data processing result.

In some optional implementations of this embodiment, the execution subject may perform Step 201 in the following manner:

First step: During the video interaction process, determine the position of the spatially directional action on the video frame.

In this implementation, during the video interaction process between the user and the large model, the execution subject collects the user input information, the video frame of the user terminal device, and the user spatially directional action for the video frame in real time, and performs temporal alignment on the multi-modal data (input information, video frame, and spatially directional action). It should be noted that the collection of the above multi-modal data is performed with the user authorization.

For a spatially directional action performed by the user via a mouse: First, the absolute coordinates of the mouse pointer on the screen are captured by the terminal device; then, based on the actual display area of the current video frame on the screen, the absolute coordinates are mapped to pixel coordinates relative to the original resolution of the video via horizontal and vertical scaling ratios, and the position of the mouse pointer in the video frame is determined.

For a spatially directional action performed by the user via screen touch: First, the absolute coordinates of the user touch on the screen are captured by the terminal device; then, based on the transformation matrix generated by the stretching, cropping, or rotation of the video frame, and combining the ratio between the original size of the video and the display area, the absolute coordinates are reversed to the original coordinate system of the video frame, and the accurate position of the touch point in the video frame is determined.

Second step: Determine the target object at the position in the video frame.

As an example, the execution subject may input the video frame and the position into a target object recognition model, which outputs the target object at the position in the video frame.

This implementation provides a target object recognition method combining spatially directional actions. Based on the clear pointing of the action, the recognition efficiency and accuracy of the target object are improved.

In some optional implementations of this embodiment, the execution subject may perform the second step in the following manner: determine the target object at the position in the video frame according to the description part of the recognized text of the input information with the same timestamp as the spatially directional action.

As an example, temporal alignment may be performed between the recognized text and the spatially directional action to determine the description part of the recognized text with the same timestamp as the spatially directional action; semantic understanding of the description part is performed to determine the semantic information of the target object; and the target object at the position in the video frame is determined based on the semantic information.

In this implementation, on the basis of the spatially directional action, the target object in the video frame is further determined according to the description part of the recognized text of the input information with the same timestamp as the spatially directional action, which helps to further improve the recognition efficiency and accuracy of the target object.

In some optional implementations of this embodiment, the execution subject may perform the first step in the following manner: During the video interaction process, determine the target position range according to the position points of the action trajectory represented by the spatially directional action on multiple video frames.

In this implementation, the execution subject may determine whether the position of the spatially directional action in the video frame moves. In response to determining that the position moves, it is determined that the spatially directional action is represented by an action trajectory. The position points of the action trajectory on multiple video frames are determined, and the target position range represented by the multiple position points is determined.

For example, for each video frame (a frame of a video) touched by the user spatially directional action, the position point of the spatially directional action in the video frame is determined. The multiple position points are connected according to the temporal sequence of the video frames, and the action trajectory of the spatially directional action in the video is determined. The target position range indicated by the spatially directional action (e.g., circling or drawing) is determined.

In this implementation, the execution subject may perform the second step in the following manner: perform object recognition within the target position range in the video frame, and determine the target object.

In response to recognizing one object within the target position range in the video frame, the object is determined as the target object; in response to recognizing multiple objects within the target position range in the video frame, semantic understanding of the description part of the recognized text with the same timestamp as the spatially directional action is performed to determine the semantic information of the target object, and the target object is determined from the multiple objects based on the semantic information.

When the semantic information of the target object is relatively vague, a confirmation request may be sent to the user for the recognized multiple objects, so that the target object is filtered from the multiple objects based on the user's instruction.

This implementation provides a method for recognizing a target object within a target position range. It supports the user to indicate the target object through an action sequence, which improves the flexibility of the user actions and the user experience during human-computer interaction.

In some optional implementations of this embodiment, the execution subject may perform the process of determining the target position range in the following manner:

First, during the video interaction process, the hot zone directed by the spatially directional action is determined according to the position points of the action trajectory represented by the spatially directional action on multiple video frames and the attribute information of the action trajectory.

The attribute information of the action trajectory includes but is not limited to shape, speed, and dwell time. The action trajectory data represented by the captured position points is input into a pre-trained directional intention judgment model. The model can understand the directional intention represented by different trajectory patterns. For example, the model can recognize that the user is performing a spatially directional action such as circling or drawing. Further, the model analyzes the features of the pointer movement trajectory (e.g., shape, speed, and dwell time) and combines the video frame to predict the hot zone directed by the user intention.

Then, the target position range is determined according to the hot zone.

As an example, the position range represented by the hot zone may be used as the target position range.

In this implementation, the target position range is determined according to the position points of the action trajectory on multiple video frames and the attribute information of the action trajectory, which improves the accuracy of the target position range.

In some optional implementations of this embodiment, the execution subject may perform the first step in the following manner: During the video interaction process, determine the position point of the instantaneous action represented by the spatially directional action on the video frame.

Instantaneous actions include, for example, mouse clicks and screen touches.

In this implementation, the execution subject may determine whether the position of the spatially directional action in the video frame moves. In response to determining that the position does not move, it is determined that the spatially directional action is an instantaneous action, and the position point of the spatially directional action on the video frame is determined.

In this implementation, the execution subject may perform the first step in the following manner: perform object recognition at the position point in the video frame, and determine the target object.

The position point is a point on or adjacent to the target object. Object recognition may be performed on the object corresponding to the position point to obtain the target object.

This implementation provides a method for recognizing a target object based on a position point, which supports the user to indicate the target object through an instantaneous action, which improves the flexibility of the user actions and the user experience during human-computer interaction.

In some optional implementations of this embodiment, the video interaction process includes a video call process, a screen sharing process, and a video dialogue process. That is, the video frame may be a video frame displayed in a video call interface, a video frame displayed in a screen sharing interface, or a video frame in a video dialogue between the user and the large model.

Taking a video frame displayed in a video call interface as an example: the user may conduct a video call with another user or the large model. The execution subject collects the video frame displayed in the video call interface, the user spatially directional action, and the user input information in real time.

In applications such as AI video calls or video stream analysis, the user can directly point to objects, people, or scenes in the real world as if communicating with a real person. The large model can understand the target object pointed to by the user and conduct an accurate dialogue.

As an example, when showing a plant, the user points to a leaf of the plant with a finger (via screen touch) or a mouse pointer and asks, “Is this leaf sick?”. The execution subject can recognize that the user is pointing to the “leaf” (target object) rather than the entire plant, and determine a data processing instruction for analyzing the health status of the leaf.

Taking a video frame displayed in a screen sharing interface as an example: the user may share the screen of the terminal device with the execution subject, so that the execution subject collects the video frame displayed in the video call interface, the spatially directional action of the user, and the input information of the user in real time.

In some AI screen sharing collaboration tools, the user shares the screen content of their terminal device (computer or mobile phone) with the large model. The large model can understand any UI (User Interface) element, text, image, or chart pointed to by the user on the screen, and determine a data processing instruction for the target object on the shared screen.

As an example, when sharing a presentation, the user hovers the mouse pointer over a specific word on a page and asks, “What is the definition of this word?” via voice. The execution subject can generate a data processing instruction for determining the definition of the word.

Taking a video frame in a dialogue as an example: the user may send a pre-recorded video to the large model. During the video recording process, the user performs a spatially directional action and inputs information. For example, during the video recording process, the user points to a target object in the real scene with a finger and speaks. The user terminal device captures the frame of the real scene and the user voice to obtain the recorded video. As another example, the user records the content displayed on the screen of the terminal device via screen recording (including the spatially directional action performed by the user via a mouse pointer) and collects the user voice during the screen recording process to obtain the recorded video.

In scenarios such as video calls, screen sharing, and video dialogues, the user can intuitively express their intention by combining spatially directional actions and information input (e.g., “pointing” and “speaking”). This reduces communication costs in the human-computer interaction process and improves the efficiency of understanding user intentions and the accuracy of data processing during human-computer interaction.

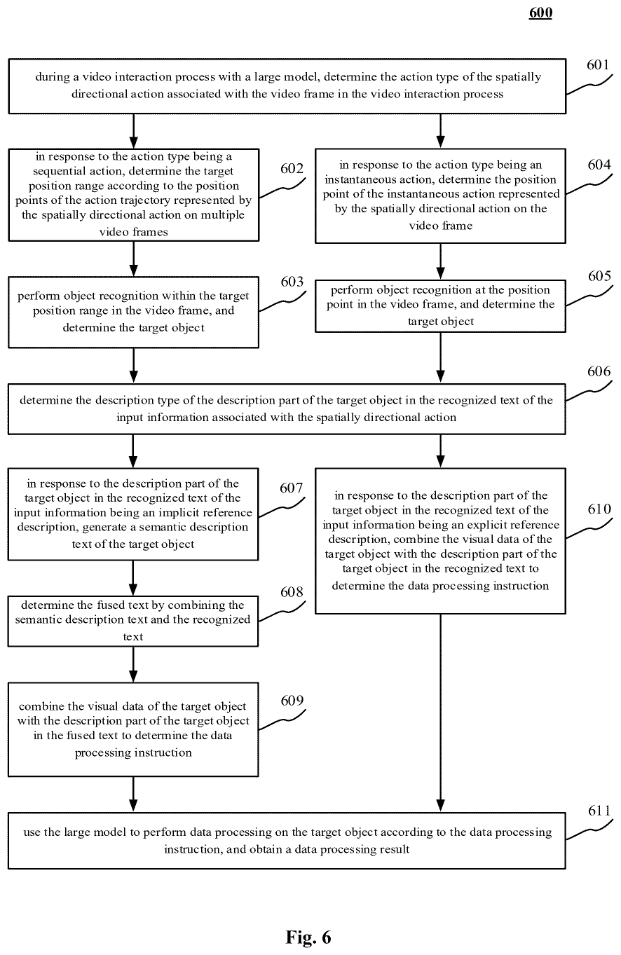

Continuing to refer to FIG. 6, a schematic flowchart 600 of the method for video interaction based on a large model according to another embodiment of the present disclosure is shown. The process 600 includes the following steps:

Step 601: during a video interaction process with a large model, determine the action type of the spatially directional action associated with the video frame in the video interaction process.

The action types include sequential actions and instantaneous actions.

Step 602: in response to the action type being a sequential action, determine the target position range according to the position points of the action trajectory represented by the spatially directional action on multiple video frames.

Step 603: perform object recognition within the target position range in the video frame, and determine the target object.

Step 604: in response to the action type being an instantaneous action, determine the position point of the instantaneous action represented by the spatially directional action on the video frame.

Step 605: perform object recognition at the position point in the video frame, and determine the target object.

Step 606: determine the description type of the description part of the target object in the recognized text of the input information associated with the spatially directional action.

The description types include implicit reference descriptions and explicit reference descriptions.

Step 607: in response to the description part of the target object in the recognized text of the input information being an implicit reference description, generate a semantic description text of the target object.

Step 608: determine the fused text by combining the semantic description text and the recognized text.

Step 609: combine the visual data of the target object with the description part of the target object in the fused text to determine the data processing instruction.

Step 610: in response to the description part of the target object in the recognized text of the input information being an explicit reference description, combine the visual data of the target object with the description part of the target object in the recognized text to determine the data processing instruction.

Step 611: use the large model to perform data processing on the target object according to the data processing instruction, and obtain a data processing result.

Compared with the above process 200, the process 600 of the method for video interaction based on a large model in this embodiment specifically describes the object recognition process based on spatially directional actions and the generation process of the data processing instruction. It allows the user to express intentions in an intuitive manner by combining spatially directional actions and information input (e.g., “pointing” and “speaking”), which further reduces communication costs in the human-computer interaction process and improves the efficiency of understanding user intentions and the accuracy of processing during human-computer interaction.

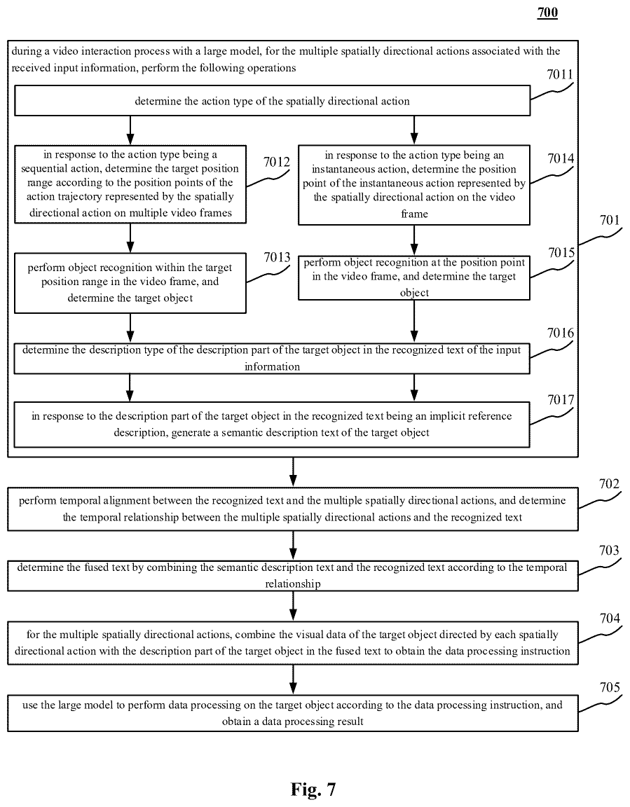

Continuing to refer to FIG. 7, a schematic flowchart 700 of the method for video interaction based on a large model according to yet another embodiment of the present disclosure is shown. The process 700 includes the following steps:

Step 701: during a video interaction process with a large model, for the multiple spatially directional actions associated with the received input information, perform the following operations:

Step 7011: determine the action type of the spatially directional action.

Step 7012: in response to the action type being a sequential action, determine the target position range according to the position points of the action trajectory represented by the spatially directional action on multiple video frames.

Step 7013: perform object recognition within the target position range in the video frame, and determine the target object.

Step 7014: in response to the action type being an instantaneous action, determine the position point of the instantaneous action represented by the spatially directional action on the video frame.

Step 7015: perform object recognition at the position point in the video frame, and determine the target object.

Step 7016: determine the description type of the description part of the target object in the recognized text of the input information.

Step 7017: in response to the description part of the target object in the recognized text being an implicit reference description, generate a semantic description text of the target object.

Step 702: perform temporal alignment between the recognized text and the multiple spatially directional actions, and determine the temporal relationship between the multiple spatially directional actions and the recognized text.

Step 703: determine the fused text by combining the semantic description text and the recognized text according to the temporal relationship.

Step 704: for the multiple spatially directional actions, combine the visual data of the target object directed by each spatially directional action with the description part of the target object in the fused text to obtain the data processing instruction.

Step 705: use the large model to perform data processing on the target object according to the data processing instruction, and obtain a data processing result.

Compared with the above process 200, the process 700 of the method for video interaction based on a large model in this embodiment specifically describes the object recognition process for multiple spatially directional actions and the generation process of the data processing instruction. It allows the user to express intentions in an intuitive manner by combining spatially directional actions and information input (e.g., “pointing” and “speaking”), which further reduces communication costs in the human-computer interaction process and improves the efficiency of understanding user intentions and the accuracy of processing during human-computer interaction.

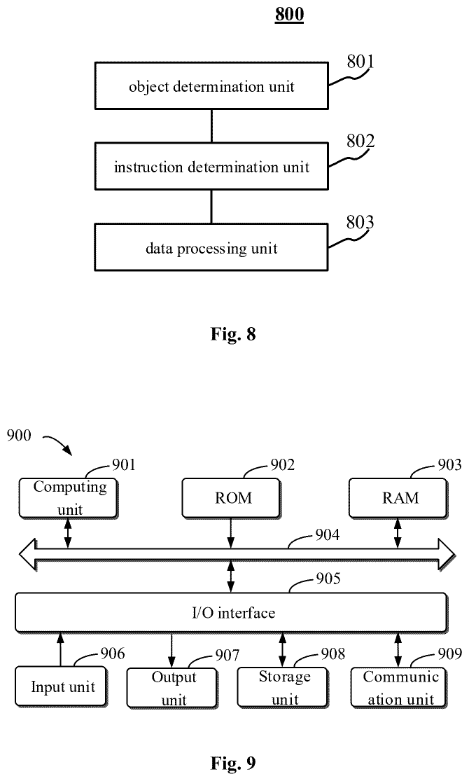

Continuing to refer to FIG. 8, as an implementation of the methods shown in the above figures, the present disclosure provides an embodiment of an apparatus for video interaction based on a large model. This apparatus embodiment corresponds to the method embodiment shown in FIG. 2, and the apparatus may be specifically applied to various electronic devices.

As shown in FIG. 8, the apparatus for video interaction based on a large model 800 includes: an object determination unit 801 configured to determine, during a video interaction process with a large model, a target object directed by a spatially directional action associated with the video frame in the video interaction process; an instruction determination unit 802 configured to determine a data processing instruction for the target object based on the input information associated with the spatially directional action; and a data processing unit 803 configured to use the large model to perform data processing on the target object according to the data processing instruction and obtain a data processing result.

In some optional implementations of this embodiment, the instruction determination unit 802 is further configured to: generate a semantic description text of the target object in response to the description part of the target object in the recognized text of the input information being an implicit reference description; and determine the data processing instruction by combining the semantic description text and the recognized text.

In some optional implementations of this embodiment, the instruction determination unit 802 is further configured to: determine the fused text by combining the semantic description text and the recognized text; and combine the visual data of the target object with the description part of the target object in the fused text to determine the data processing instruction.

In some optional implementations of this embodiment, the instruction determination unit 802 is further configured to: combine the visual data of the target object with the description part of the target object in the recognized text to determine the data processing instruction in response to the description part of the target object in the recognized text of the input information being an explicit reference description.

In some optional implementations of this embodiment, the input information is associated with multiple spatially directional actions, and the instruction determination unit 802 is further configured to: generate a semantic description text of the target object for the multiple spatially directional actions in response to the description part of the target object directed by each spatially directional action in the recognized text of the input information being an implicit reference description; perform temporal alignment between the recognized text of the input information and the multiple spatially directional actions, and determine the temporal relationship between the multiple spatially directional actions and the recognized text; and determine the data processing instruction by combining the semantic description text and the recognized text according to the temporal relationship.

In some optional implementations of this embodiment, the instruction determination unit 802 is further configured to: determine the fused text by combining the semantic description text and the recognized text according to the temporal relationship; and for the multiple spatially directional actions, combine the visual data of the target object directed by each spatially directional action with the description part of the target object in the fused text to obtain the data processing instruction.

In some optional implementations of this embodiment, the data processing unit 803 is further configured to: use the large model to perform data processing on the target object according to the data processing instruction, the context of the input information, and the video frame, and obtain a data processing result.

In some optional implementations of this embodiment, the object determination unit 801 is further configured to: determine the position of the spatially directional action on the video frame during the video interaction process; and determine the target object at the position in the video frame.

In some optional implementations of this embodiment, the object determination unit 801 is further configured to: determine the target object at the position in the video frame according to the description part of the recognized text of the video with the same timestamp as the spatially directional action.

In some optional implementations of this embodiment, the object determination unit 801 is further configured to: determine the target position range according to the position points of the action trajectory represented by the spatially directional action on multiple video frames during the video interaction process; and perform object recognition within the target position range in the video frame to determine the target object.

In some optional implementations of this embodiment, the object determination unit 801 is further configured to: determine the hot zone directed by the spatially directional action according to the position points of the action trajectory represented by the spatially directional action on multiple video frames and the attribute information of the action trajectory during the video interaction process; and determine the target position range according to the hot zone.

In some optional implementations of this embodiment, the object determination unit 801 is further configured to: determine the position point of the instantaneous action represented by the spatially directional action on the video frame during the video interaction process; and perform object recognition at the position point in the video frame to determine the target object.

In some optional implementations of this embodiment, the video interaction process includes a video call process, a screen sharing process, and a video dialogue process.

In this embodiment, an apparatus for video interaction based on a large model is provided. During the video interaction process with the large model, the target object directed by the spatially directional action associated with the video frame is determined; a data processing instruction for the target object is determined based on the input information associated with the spatially directional action; and the large model is used to perform data processing on the target object according to the data processing instruction to obtain a data processing result. Thus, a human-computer interaction mode combining multi-modal data (spatially directional actions, video frames, and input information) is provided, allowing users to express intentions in an intuitive manner by combining spatially directional actions and information input (e.g., “pointing” and “speaking”). This reduces communication costs in the human-computer interaction process and improves the efficiency of understanding user intentions and the accuracy of processing during human-computer interaction.

According to the embodiments of the present disclosure, the present disclosure further provides an electronic device. The electronic device includes: at least one processor; and a memory communicatively connected to the at least one processor. The memory stores instructions executable by the at least one processor, and the instructions are executed by the at least one processor to enable the at least one processor to implement the method for video interaction based on a large model described in any of the above embodiments when executing the instructions.

According to the embodiments of the present disclosure, the present disclosure further provides a readable storage medium. The readable storage medium stores computer instructions, and the computer instructions are used to enable a computer to implement the method for video interaction based on a large model described in any of the above embodiments when executed.

An embodiment of the present disclosure provides a computer program product, which, when executed by a processor, enables the implementation of the method for video interaction based on a large model described in any of the above embodiments.

FIG. 9 shows a schematic block diagram of an exemplary electronic device 900 that can be used to implement the embodiments of the present disclosure. The electronic device is intended to represent various forms of digital computers, such as laptops, desktops, workstations, personal digital assistants, servers, blade servers, mainframes, and other suitable computers. The electronic device may also represent various forms of mobile devices, such as personal digital assistants, cellular phones, smartphones, wearable devices, and other similar computing devices. The components shown herein, their connections and relationships, and their functions are merely examples and are not intended to limit the implementation of the present disclosure described and/or claimed herein.

As shown in FIG. 9, the device 900 includes a computing unit 901, which can execute various appropriate actions and processes according to a computer program stored in a read-only memory (ROM) 902 or a computer program loaded from a storage unit 908 into a random access memory (RAM) 903. In the RAM 903, various programs and data required for the operation of the device 900 can also be stored. The computing unit 901, the ROM 902, and the RAM 903 are connected to each other via a bus 904. An input/output (I/O) interface 905 is also connected to the bus 904.

Multiple components in the device 900 are connected to the I/O interface 905, including: an input unit 906 (e.g., a keyboard, a mouse); an output unit 907 (e.g., various types of displays, speakers); a storage unit 908 (e.g., a magnetic disk, an optical disk); and a communication unit 909 (e.g., a network card, a modem, a wireless communication transceiver). The communication unit 909 allows the device 900 to exchange information/data with other devices via a computer network such as the Internet and/or various telecommunication networks.

The computing unit 901 may be various general-purpose and/or special-purpose processing components with processing and computing capabilities. Some examples of the computing unit 901 include, but are not limited to, a central processing unit (CPU), a graphics processing unit (GPU), various artificial intelligence (AI) computing chips, various computing units running machine learning model algorithms, a digital signal processor (DSP), and any suitable processor, controller, microcontroller, etc. The computing unit 901 executes the various methods and processes described above, such as the method for video interaction based on a large model. For example, in some embodiments, the method for video interaction based on a large model may be implemented as a computer software program tangibly embodied in a machine-readable medium, such as the storage unit 908. In some embodiments, part or all of the computer program may be loaded and/or installed on the device 900 via the ROM 902 and/or the communication unit 909. When the computer program is loaded into the RAM 903 and executed by the computing unit 901, one or more steps of the method for video interaction based on a large model described above may be executed. Alternatively, in other embodiments, the computing unit 901 may be configured to execute the method for video interaction based on a large model by any other suitable means (e.g., via firmware).

Various implementations of the systems and technologies described herein may be implemented in digital electronic circuitry, integrated circuits, field-programmable gate arrays (FPGAs), application-specific integrated circuits (ASICs), application-specific standard products (ASSPs), systems-on-a-chip (SoCs), complex programmable logic devices (CPLDs), computer hardware, firmware, software, and/or combinations thereof. These various implementations may include: being implemented in one or more computer programs that can be executed and/or interpreted on a programmable system including at least one programmable processor, which may be a dedicated or general-purpose programmable processor, and can receive data and instructions from a storage system, at least one input device, and at least one output device, and transmit data and instructions to the storage system, the at least one input device, and the at least one output device.

Program code for implementing the method of the present disclosure may be written in any combination of one or more programming languages. These program codes may be provided to a processor or controller of a general-purpose computer, a dedicated computer, or other programmable apparatus for video interaction based on a large model, so that the program codes, when executed by the processor or controller, cause the functions/operations specified in the flowcharts and/or block diagrams to be implemented. The program codes may be executed entirely on a machine, partially on a machine, partially on a machine and partially on a remote machine as a stand-alone software package, or entirely on a remote machine or server.

In the context of the present disclosure, a machine-readable medium may be a tangible medium that can contain or store a program for use by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the above. More specific examples of the machine-readable storage medium would include an electrical connection based on one or more wires, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the above.

To provide interaction with a user, the systems and technologies described herein may be implemented on a computer having: a display device (e.g., a CRT (cathode ray tube) or LCD (liquid crystal display) monitor) for displaying information to the user; and a keyboard and a pointing device (e.g., a mouse or a trackball) through which the user can provide input to the computer. Other types of devices may also be used to provide interaction with a user; for example, feedback provided to the user may be any form of sensory feedback (e.g., visual feedback, auditory feedback, or tactile feedback); and input from the user may be received in any form, including acoustic input, speech input, or tactile input.

The systems and technologies described herein may be implemented in a computing system that includes backend components (e.g., as a data server), or a computing system that includes middleware components (e.g., an application server), or a computing system that includes frontend components (e.g., a user computer having a graphical user interface or a web browser through which the user can interact with an implementation of the systems and technologies described herein), or a computing system that includes any combination of such backend components, middleware components, or frontend components. The components of the system may be interconnected by any form or medium of digital data communication (e.g., a communication network). Examples of communication networks include: a local area network (LAN), a wide area network (WAN), and the Internet.

The computer system may include a client and a server. The client and the server are generally remote from each other and typically interact through a communication network. The relationship between the client and the server is generated by computer programs running on the respective computers and having a client-server relationship with each other. The server may be a cloud server, also known as a cloud computing server or a cloud host, which is a host product in the cloud computing service system to solve the defects of difficult management and weak business scalability in traditional physical hosts and virtual private servers (VPS). The server may also be a distributed system server or a server incorporating a blockchain.

According to the technical solution of the embodiment of the present disclosure, a method for video interaction based on a large model and apparatus are provided. During the video interaction process with the large model, the target object directed by the spatially directional action associated with the video frame is determined; a data processing instruction for the target object is determined based on the input information associated with the spatially directional action; and the large model is used to perform data processing on the target object according to the data processing instruction to obtain a data processing result. Thus, a human-computer interaction mode combining multi-modal data (spatially directional actions, video frames, and input information) is provided, allowing users to express intentions in an intuitive manner by combining spatially directional actions and information input (e.g., “pointing” and “speaking”). This reduces communication costs in the human-computer interaction process and improves the efficiency of understanding user intentions and the accuracy of processing during human-computer interaction.

It should be understood that the various forms of processes shown above may be used to reorder, add, or delete steps. For example, the steps described in the present disclosure may be executed in parallel, sequentially, or in a different order, as long as the desired result of the technical solution of the present disclosure can be achieved, and no limitation is imposed herein.

The foregoing detailed description is not intended to limit the scope of the present disclosure. It will be appreciated by those skilled in the art that various modifications, combinations, sub-combinations, and substitutions may be made depending on design requirements and other factors. Any modifications, equivalents, and modifications that fall within the spirit and principles of the disclosure are intended to be included within the scope of protection of the disclosure.

What is claimed is:

1. A method for video interaction based on a large model, comprising:
determining, during a video interaction process with the large model, a target object directed by a spatially directional action associated with a video frame in the video interaction process;
determining a data processing instruction for the target object according to input information associated with the spatially directional action; and
using the large model to perform data processing on the target object according to the data processing instruction, to obtain a data processing result.

2. The method according to claim 1, wherein the determining, during the video interaction process with the large model, the target object directed by the spatially directional action associated with the video frame in the video interaction process comprises:
in response to a description part of the target object in a recognized text of the input information being an implicit reference description, generating a semantic description text of the target object; and
combining the semantic description text and the recognized text to determine the data processing instruction.

3. The method according to claim 2, wherein the combining the semantic description text and the recognized text to determine the data processing instruction comprises:
combining the semantic description text and the recognized text to determine a fused text; and
incorporating visual data of the target object into the description part of the target object in the fused text, to determine the data processing instruction.

4. The method according to claim 1, wherein the determining the data processing instruction for the target object according to the input information associated with the spatially directional action comprises:
in response to a description part of the target object in a recognized text of the input information being an explicit reference description, incorporating visual data of the target object into the description part of the target object in the recognized text, to determine the data processing instruction.

5. The method according to claim 1, wherein the input information is associated with a plurality of the spatially directional actions, and the determining the data processing instruction for the target object according to the input information associated with the spatially directional actions comprises:
for the plurality of spatially directional actions, in response to a description part of the target object directed by each spatially directional action in a recognized text of the input information being an implicit reference description, generating a semantic description text of the target object;
performing temporal alignment between the recognized text of the input information and the plurality of spatially directional actions, to determine a temporal corresponding relationship between the plurality of spatially directional actions and the recognized text; and
combining the semantic description text and the recognized text according to the temporal relationship to determine the data processing instruction.

6. The method according to claim 5, wherein the combining the semantic description text and the recognized text according to the temporal relationship to determine the data processing instruction comprises:
combining the semantic description text and the recognized text according to the temporal relationship to determine a fused text; and
for the plurality of spatially directional actions, incorporating visual data of the target object directed by each spatially directional action into the description part of the corresponding target object in the fused text, to obtain the data processing instruction.

7. The method according to claim 1, wherein the using the large model to perform data processing on the target object according to the data processing instruction to obtain a data processing result comprises:
using the large model to perform data processing on the target object according to the data processing instruction, context of the input information and the video frame, to obtain the data processing result.

8. The method according to claim 1, wherein the determining the target object directed by the spatially directional action associated with the video frame in the video interaction process during the video interaction with the large model comprises:
during the video interaction process, determining a position of the spatially directional action on the video frame; and
determining the target object at the position in the video frame.

9. The method according to claim 8, wherein the determining the target object at the position in the video frame comprises:
determining the target object at the position in the video frame according to the description part time-synchronized with the spatially directional action in the recognized text of the input information.

10. The method according to claim 8, wherein the determining the position of the spatially directional action on the video frame during the video interaction process comprises:
during the video interaction process, determining a target position range according to a plurality of position points of a motion trajectory represented by the spatially directional action on the video frame; and
determining the target object at the position in the video frame comprises: performing object recognition within the target position range in the video frame to determine the target object.

11. The method according to claim 10, wherein the determining the target position range according to the plurality of position points of the motion trajectory represented by the spatially directional action on the video frame during the video interaction process comprises:
during the video interaction process, determining a hot zone targeted by the spatially directional action according to the plurality of position points of the motion trajectory represented by the spatially directional action on the video frame and attribute information of the motion trajectory; and
determining the target position range according to the hot zone.

12. The method according to claim 8, wherein the determining the position of the spatially directional action on the video frame during the video interaction process comprises:
during the video interaction process, determining a position point of an instantaneous action represented by the spatially directional action on the video frame; and
the determining the target object at the said position in the video frame comprises performing object recognition at the position point in the video frame to determine the target object.

13. The method according to claim 1, wherein the video interaction process comprises a video call process, a screen sharing process and a video conversation process.

14. An electronic device, comprising:
at least one processor; and
a memory communicatively connected to the at least one processor; wherein, the memory stores instructions executable by the at least one processor, and the instructions are executed by the at least one processor to enable the at least one processor to perform operations comprising:
determining, during a video interaction process with a large model, a target object directed by a spatially directional action associated with a video frame in the video interaction process;
determining a data processing instruction for the target object according to input information associated with the spatially directional action; and
using the large model to perform data processing on the target object according to the data processing instruction, to obtain a data processing result.

15. The electronic device according to claim 14, wherein the determining, during the video interaction process with the large model, the target object directed by the spatially directional action associated with the video frame in the video interaction process comprises:
in response to a description part of the target object in a recognized text of the input information being an implicit reference description, generating a semantic description text of the target object; and
combining the semantic description text and the recognized text to determine the data processing instruction.

16. The electronic device according to claim 15, wherein the combining the semantic description text and the recognized text to determine the data processing instruction comprises:
combining the semantic description text and the recognized text to determine a fused text; and
incorporating visual data of the target object into the description part of the target object in the fused text, to determine the data processing instruction.

17. The electronic device according to claim 14, wherein the determining the data processing instruction for the target object according to the input information associated with the spatially directional action comprises:
in response to a description part of the target object in a recognized text of the input information being an explicit reference description, incorporating visual data of the target object into the description part of the target object in the recognized text, to determine the data processing instruction.

18. The electronic device according to claim 14, wherein the input information is associated with a plurality of the spatially directional actions, and the determining the data processing instruction for the target object according to the input information associated with the spatially directional actions comprises:
for the plurality of spatially directional actions, in response to a description part of the target object directed by each spatially directional action in a recognized text of the input information being an implicit reference description, generating a semantic description text of the target object;
performing temporal alignment between the recognized text of the input information and the plurality of spatially directional actions, to determine a temporal corresponding relationship between the plurality of spatially directional actions and the recognized text; and
combining the semantic description text and the recognized text according to the temporal relationship to determine the data processing instruction.

19. The electronic device according to claim 18, wherein the combining the semantic description text and the recognized text according to the temporal relationship to determine the data processing instruction comprises:
combining the semantic description text and the recognized text according to the temporal relationship to determine a fused text; and
for the plurality of spatially directional actions, incorporating visual data of the target object directed by each spatially directional action into the description part of the corresponding target object in the fused text, to obtain the data processing instruction.

20. A non-transitory computer-readable storage medium storing computer instructions, wherein the computer instructions are used to cause a computer to perform operations comprising:
determining, during a video interaction process with the large model, a target object directed by a spatially directional action associated with a video frame in the video interaction process;
determining a data processing instruction for the target object according to input information associated with the spatially directional action; and
using the large model to perform data processing on the target object according to the data processing instruction, to obtain a data processing result.
